(19) United States
(12) Patent Application Publication
(10) Pub. No.: US 2022/0292963 A1
(43) Pub. Date: Sep. 15, 2022

(54) DRIVING ASSISTANCE DEVICE, DRIVING ASSISTANCE METHOD, AND PROGRAM

(71) Applicant: HONDA MOTOR CO., LTD., Tokyo (JP)

(72) Inventor: Masakazu Kita, Wako-shi (JP)

(21) Appl. No.: 17/674,870

(22) Filed: Feb. 18, 2022

(30) Foreign Application Priority Data
Mar. 11, 2021 (JP) 2021-039287

(51) Int. Cl. G08G 1/0962; G06V 20/58; G06V 20/56

(52) U.S. Cl. CPC G08G 1/09626; G06V 20/584; G06V 20/588

(57) ABSTRACT

A driving assistance device includes a recognizer and a notifier. The recognizer, based on an image of a front in a vehicle, recognizes an advancing feasibility indication by a traffic signal and reference objects present between the traffic signal and the vehicle. The notifier, in a case where there is a predetermined type of reference object among the reference objects recognized by the recognizer, uses a rear end of the predetermined type of reference object as a reference, and controls a notification device such that a notification is provided to an occupant of the vehicle according to a distance from the reference to the vehicle and a recognition result of the advancing feasibility indication.

### CROSS-REFERENCE TO RELATED APPLICATION

Priority is claimed on Japanese Patent Application No. 2021-039287, filed on Mar. 11, 2021, the contents of which are incorporated herein by reference.

### BACKGROUND

### Field of the Invention

The present invention relates to a driving assistance device, a driving assistance method, and a program.

### Background

There is a technique for assisting an occupant in driving such that a vehicle can stop in front of an intersection with a margin by notifying the occupant of the vehicle that a traffic signal indicates that advancing is not permitted. For example, Japanese Unexamined Patent Application, First Publication No. 2012-203785 discloses a technique in which a location separated from a reference location such as the center of an intersection by a predetermined distance is set as a control reference location, and in a case where a vehicle has not gone beyond the control reference location and it is determined that the vehicle will not be able to pass through the intersection on the basis of information received from a traffic signal, a notification is provided.

### SUMMARY

In Japanese Unexamined Patent Application, First Publication No. 2012-203785, a predetermined location in an intersection is used as a reference location to determine a location for determining whether or not to notify an occupant. However, depending on situations of an intersection, vehicles traveling in front of an own vehicle, or the like, it may be desirable to dynamically determine a position for reporting information regarding advancing feasibility.

An object of the present invention is to provide a driving assistance device, a driving assistance method, and a program capable of determining a position for notifying an occupant of a vehicle according to a situation on the basis of information regarding advancing feasibility indicated by a traffic signal.

According to a first aspect of the present invention, a driving assistance device is provided including a recognizer that, based on an image of a front in a vehicle, recognizes an advancing feasibility indication by a traffic signal and reference objects present between the traffic signal and the vehicle; and a notification controller that, in a case where there is a predetermined type of reference object among the reference objects recognized by the recognizer, uses a rear end of the predetermined type of reference object as a reference, and controls a notification device such that a notification is provided to an occupant of the vehicle according to a distance from the reference to the vehicle and a recognition result of the advancing feasibility indication.

A second aspect is the driving assistance device of the first aspect, wherein the predetermined type of reference object may include a stop line and another vehicle present in front of the vehicle in a lane in which the vehicle is traveling, and, in a case where the recognized reference objects include the stop line and the other vehicle, the notification controller may use a rear end of a reference object, which is any one of the stop line and the other vehicle and which is closer to the vehicle, as the reference.

A third aspect is the driving assistance device of the second aspect, wherein the predetermined type of reference object may further include a pedestrian crossing, and, in a case where the recognized reference objects do not include the stop line and include the pedestrian crossing and the other vehicle, the notification controller may use a rear end of a reference object, which is any one of the pedestrian crossing and the other vehicle and which is closer to the vehicle, as the reference.

A fourth aspect is the driving assistance device of the third aspect, wherein the predetermined type of reference object may further include an intersection end, and, in a case where the recognized reference objects do not include the stop line and the pedestrian crossing, and include the intersection end and the other vehicle, the notification controller may use a rear end of a reference object, which is any one of the intersection end and the other vehicle and which is closer to the vehicle, as the reference.

A fifth aspect is the driving assistance device of the fourth aspect, wherein in a case where the recognized reference objects do not include any of the stop line, the pedestrian crossing, and the intersection end, the notification controller may use a position, which is any one of a position at a predetermined distance from the traffic signal in a direction of the vehicle and a position of the rear end of the other vehicle and which is closer to the vehicle, as the reference.

A sixth aspect is the driving assistance device of any one of the second to fifth aspects, wherein the notification controller may control the notification device such that the notification is stopped in a case where a distance between the vehicle and the other vehicle is equal to or shorter than a predetermined distance.

A seventh aspect is the driving assistance device of any one of the first to the sixth aspects, wherein the notification controller may control the notification device such that the notification is provided according to the recognition result of the advancing possibility indication and a speed of the vehicle.

An eighth aspect is the driving assistance device of any one of the first to seventh aspects, wherein the notification controller may control the notification device such that the notification is provided in a case where a distance between the reference and the vehicle is within a distance corresponding to a speed of the vehicle.

A ninth aspect is the driving assistance device of any one of the first to eighth aspects, wherein the vehicle may include an image acquirer that acquires the image of the front in the vehicle.

According to a tenth aspect, there is provided a driving assistance method by way of a computer, comprising: based on an image of a front in a vehicle, recognizing an advancing feasibility indication by a traffic signal and reference objects present between the traffic signal and the vehicle; and, in a case where there is a predetermined type of reference object among the recognized reference objects, using a rear end of the predetermined type of reference object as a reference, and controlling a notification device such that a notification is provided to an occupant of the vehicle according to a distance from the reference to the vehicle and a recognition result of the advancing feasibility indication.

According to an eleventh aspect of the present invention, a non-transitory computer readable recording medium is provided including a program causing a computer to: based on an image of a front in a vehicle, recognize an advancing feasibility indication by a traffic signal and reference objects present between the traffic signal and the vehicle; and, in a case where there is a predetermined type of reference object among the recognized reference objects, use a rear end of the predetermined type of reference object as a reference, and control a notification device such that a notification is provided to an occupant of the vehicle according to a distance from the reference to the vehicle and a recognition result of the advancing feasibility indication.

According to the first to eleventh aspects, a reference position for calculating a position for providing a notification according to a detection result of an advancing feasibility indication by the traffic signal can be determined on the basis of a detection result of a reference object in front of the vehicle. Therefore, it is possible to provide a notification at a timing suitable for a surrounding situation of the vehicle.

According to the second aspect, it is possible to assist an occupant such that the vehicle can stop at an appropriate distance in front any one of the other vehicle and the stop line which is closer to the own vehicle.

According to the third aspect, even in a case where the stop line is not recognized, it is possible to assist an occupant such that the vehicle can stop at an appropriate distance in front of any one of the other vehicle and the pedestrian crossing which is closer to the own vehicle.

According to the fourth aspect, even in a case where the stop line and the pedestrian crossing are not recognized, it is possible to assist an occupant such that the vehicle can stop at an appropriate distance in front of any one of the other vehicle and the intersection end which is closer to the own vehicle.

According to the fifth aspect, even in a case where the stop line, the pedestrian crossing, and the intersection end are not recognized, it is possible to assist an occupant such that the vehicle can stop at an appropriate distance in front of any one of the other vehicle and the vicinity of the intersection which is closer to the own vehicle.

According to the sixth aspect, it is possible to make it easier for an occupant to pay attention to the front by stopping the notification in a case where the own vehicle gets too close to the other vehicle.

According to the seventh aspect, even in a case where the detection result of advancing feasibility indication by the traffic signal is the same, it is possible to change details of the notification or to prevent the notification from being provided according to a speed of the own vehicle.

According to the eighth aspect, in a case where a speed of the own vehicle is high, an occupant is notified at an early timing that the traffic signal indicates advancing prohibition, and thus it is possible to assist the occupant such that the vehicle can stop at an appropriate distance.

According to the ninth aspect, the image of the front in the own vehicle can be easily acquired.

### BRIEF DESCRIPTION OF THE DRAWINGS

FIG. 1 is a configuration diagram of a vehicle system according to an embodiment of the present invention.

FIG. 2 is a diagram showing a reference object recognized by a driving assistance device according to the embodiment.

FIG. 3 is a diagram showing a reference object recognized by the driving assistance device according to the embodiment.

FIG. 4 is a diagram showing a reference object recognized by the driving assistance device according to the embodiment.

FIG. 5 is a flowchart showing a process of the driving assistance device according to the embodiment.

FIG. 6 is a flowchart showing a process of the driving assistance device according to the embodiment.

### DESCRIPTION OF EMBODIMENTS

Hereinafter, embodiments of a driving assistance device, a driving assistance method, and a program of the present invention will be described with reference to the drawings.

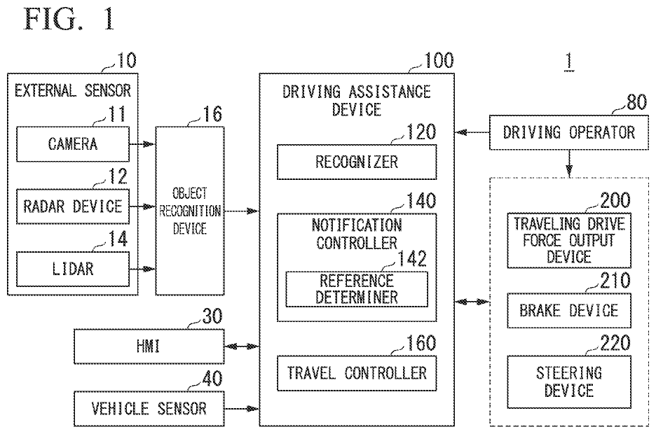

FIG. 1 is a configuration diagram of a vehicle system 1 using a driving assistance device according to an embodiment. A vehicle having the vehicle system 1 mounted therein is, for example, a two-wheeled, three-wheeled, or four-wheeled vehicle, and a drive source thereof is an internal combustion engine such as a diesel engine or a gasoline engine, a motor, or a combination thereof. The motor is operated by using power generated by a generator connected to the internal combustion engine or power released from a secondary battery or a fuel cell.

The vehicle system 1 includes, for example, an external sensor 10, an object recognition device 16, a human machine interface (HMI) 30, a vehicle sensor 40, a driving operator 80, a driving assistance device 100, a traveling drive force output device 200, a brake device 210, and a steering device 220. The devices and the apparatuses are connected to each other via a multiplex communication line such as a Controller Area Network (CAN) communication line, a serial communication line, or a wireless communication network. The configuration shown in FIG. 1 is only an example, and some of the constituents may be omitted, and other constituents may be added.

The external sensor 10 acquires external information of a vehicle (hereinafter, an own vehicle M) having the vehicle system 1 mounted therein. The external sensor 10 includes a camera 11, a radar device 12, and light detection and ranging (LIDAR) 14. The camera 11 is a digital camera using a solid-state imaging element such as a charge coupled device (CCD) or a complementary metal oxide semiconductor (CMOS). The camera 11 is attached at any location in the own vehicle M. For example, in a case of imaging the front, the camera 11 is attached to the upper part of a front windshield, the back surface of a rearview mirror, or the like. The camera 11 periodically and repeatedly images the surroundings of the own vehicle M, for example. The camera 11 may be a stereo camera.

The radar device 12 radiates electric waves such as millimeter waves in the surroundings of the own vehicle M, detects electric waves (reflected waves) reflected by an object, and thus detects at least a position of (a distance to and an azimuth of) the object. The radar device 12 is attached at any location in the own vehicle M. The radar device 12 may detect a position and a speed of an object according to a frequency modulated continuous wave (FM-CW) method.

The LIDAR 14 applies light (or an electromagnetic wave with a wavelength close to that of the light) in the surroundings of the own vehicle M, and measures scattered light. The LIDAR 14 detects a distance to a target on the basis of a time from light emission to light reception. The applied light is, for example, pulsed laser light. The LIDAR 14 is attached at any location in the own vehicle M.

The object recognition device 16 performs a sensor fusion process on detection results from some or all of the camera 11, the radar device 12, and the LIDAR 14, and thus recognizes a position, the type (attribute), a speed, and the like of an object. The object recognition device 16 outputs a recognition result to the driving assistance device 100. The object recognition device 16 may output detection results from the camera 11, the radar device 12, and the LIDAR 14 to the driving assistance device 100 without change.

The HMI 30 is a notification device that presents various types of information to an occupant of the own vehicle M. The HMI 30 receives an input operation from the occupant. The HMI 30 includes various display devices, speakers, buzzers, touch panels, switches, keys, and the like.

The vehicle sensor 40 includes a vehicle speed sensor that detects a speed of the own vehicle M, an acceleration sensor that detects acceleration, a gyro sensor that detects angular velocity about the vertical axis, an azimuth sensor that detects an orientation of the own vehicle M, and the like.

The driving operator 80 includes, for example, an accelerator pedal, a brake pedal, a shift lever, a steering wheel, an odd-shaped steering wheel, a joystick, and other operators.

The driving assistance device 100 includes a recognizer 120, a notification controller 140, and a travel controller 160. The recognizer 120, the notification controller 140, and the travel controller 160 are realized, for example, by a hardware processor such as a central processing unit (CPU) executing a program (software). Some or all of these constituents may be realized by hardware (a circuit portion; including circuitry) such as a large-scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) of the driving assistance device 100 and may be stored in an attachable and detachable storage medium such as a DVD or a CD-ROM and may be installed in an HDD or a flash memory of the driving assistance device 100 when the storage medium (non-transitory storage medium) is attached to a drive device.

The recognizer 120 is realized by combining, for example, a function of artificial intelligence (AI) with a function of a model provided in advance. For example, in a case of recognizing a traffic signal, the recognizer 120 may execute recognition of the traffic signal through deep learning and the like and recognition of the traffic signal through pattern matching in parallel and may comprehensively evaluate the recognition results of both to recognize the traffic signal. For example, in a case where an intersection is recognized, such recognition may be realized by executing recognition of the intersection using deep learning and recognition based on conditions (for example, there are a signal that can be matched with a pattern, and a road marking) given in advance in parallel, and scoring and comprehensively evaluating both of recognition results. The recognizer 120 may perform either image recognition using AI or image recognition using a model given in advance.

The recognizer 120 recognizes states such as a position, a speed, and an acceleration of an object present in the surroundings of the own vehicle M on the basis of information input from the camera 11, the radar device 12, and the LIDAR 14 via the object recognition device 16. The position of the object is recognized as, for example, a position on absolute coordinates with a representative point (for example, the centroid or the drive axis center) of the own vehicle M as the origin and is used for driving assistance. The driving assistance includes a notification provided to an occupant and traveling control of the own vehicle M.

The recognizer 120 recognizes, for example, a lane (travel lane) in which the own vehicle M is traveling. For example, the recognizer 120 compares a pattern (for example, an arrangement of solid lines and dashed lines) of road lane markings obtained from map information with a pattern of road lane markings in the surroundings of the own vehicle M recognized from an image captured by the camera 11, and thus recognizes a travel lane. The map information is stored in a storage device (not shown) provided inside or outside. The recognizer 120 is not limited to a road lane marking and may recognize a boundary representing a lane boundary (road boundary) such as a road lane marking, a road shoulder, a curb, a median strip, and a guardrail, to recognize a travel lane. The recognizer 120 recognizes road events such as stop lines and pedestrian crossings. The recognizer 120 calculates a position of a road event in the same manner as in the above position of the object on the basis of information input from the camera 11, the radar device 12, and the LIDAR 14 via the object recognition device 16.

With the above function, the recognizer 120 recognizes a traffic signal and a reference object present between the traffic signal and the own vehicle M on the basis of an image of the front in the own vehicle M captured by the camera 11. The reference object may include an object and a road event. Specifically, the reference object includes another vehicle present in the same lane as that of the own vehicle M, a temporary stop line, a pedestrian crossing, and an intersection end. The recognizer 120 can acquire positions of these recognized reference objects. The recognizer 120 recognizes a state of the traffic signal on the basis of the image. The state of the traffic signal includes an advancing feasibility indication.

The notification controller 140 controls the HMI 30 such that a notification is provided to an occupant of the own vehicle M. The notification controller 140 includes a reference determiner 142. The reference determiner 142 uses, as a calculation reference, a rear end of a reference object selected on the basis of a distance between a predetermined type of reference object and the own vehicle M among the reference objects recognized by the recognizer 120. The calculation reference is a reference for calculating a location at which a notification starts to be provided to the occupant of the own vehicle M. The rear end is a point closest to the own vehicle M in the reference object. A distance between the rear end of the reference object and the own vehicle M is calculated as a difference between a position of the rear end of the reference object recognized by the recognizer 120 and a position of the own vehicle. In the following description, a location at which the notification is started will be described as a notification start reference.

The notification controller 140 displays information based on the recognition result from the recognizer 120 on the screen of the HMI 30, or outputs the information from the speaker of the HMI 30 in sound. As an example, the notification controller 140 causes the HMI 30 to output information according to a recognition result of advancing feasibility in the traffic signal and a speed of the own vehicle M. The notification controller 140 instructs the HMI 30 to start this output at a timing at which the own vehicle M passes the notification start reference. The notification controller 140 uses a location close toward the own vehicle M from the calculation reference determined by the reference determiner 142 by a distance Ds as the notification start reference. The notification controller 140 may stop the output of information from the HMI 30 at a timing at which the own vehicle M has passed a notification end reference. The notification controller 140 uses a location close toward the own vehicle M from a predetermined type of reference object such as another vehicle by a distance De (<Ds) as the notification end reference. The distances Ds and De may be distances corresponding to recognition results from the recognizer 120 or predetermined information output by the vehicle sensor 40. For example, the notification controller 140 may determine the distances Ds and De according to a speed of the own vehicle M. Specifically, the notification controller 140 sets the distance Ds to be equal to or longer than a distance required for the own vehicle M to stop at a predetermined acceleration or less when the own vehicle M performs a braking operation while traveling at the current speed. The notification controller 140 determines the distance De on the basis of a distance required for the own vehicle M to stop in a case where the travel controller 160 controls the brake device 210 on the basis of a recognition result from the recognizer 120 while the own vehicle M is traveling at the current speed.

The travel controller 160 performs travel control on the own vehicle M. The travel control is, for example, controlling one or both of a speed and steering of the own vehicle M. The travel controller 160 controls the brake device 210 on the basis of the recognition result from the recognizer 120 or the detection result from the vehicle sensor 40. For example, the travel controller 160 controls the brake device 210 in a case where a distance between a predetermined reference object and the own vehicle M is within a predetermined distance corresponding to a speed.

The traveling drive force output device 200 outputs traveling drive force (torque) for traveling of the vehicle to drive wheels. The traveling drive force output device 200 includes, for example, a combination of an internal combustion engine, a motor, and a transmission, and an electronic control unit (ECU) controlling the constituents. The ECU controls the constituents according to information that is input from the travel controller 160 or information that is input from the driving operator 80.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor on the basis of information being input from the travel controller 160 or information being input from the driving operator 80, so that brake torque corresponding to a braking operation is output to each vehicle wheel. The brake device 210 may include, as a backup, a mechanism transmitting hydraulic pressure generated by operating the brake pedal included in the driving operator 80, to the cylinder via a master cylinder. The brake device 210 may be an electronic control type hydraulic brake device that controls an actuator according to information being input from the travel controller 160 and thus transmits hydraulic pressure in a master cylinder to the cylinder.

The steering device 220 includes, for example, a steering ECU and an electric motor.

The electric motor changes an orientation of a turning wheel by applying force to, for example, a rack-and-pinion mechanism. The steering ECU drives the electric motor on the basis of information that is input from the travel controller 160 or information that is input from the driving operator 80, such that an orientation of the turning wheel is changed.

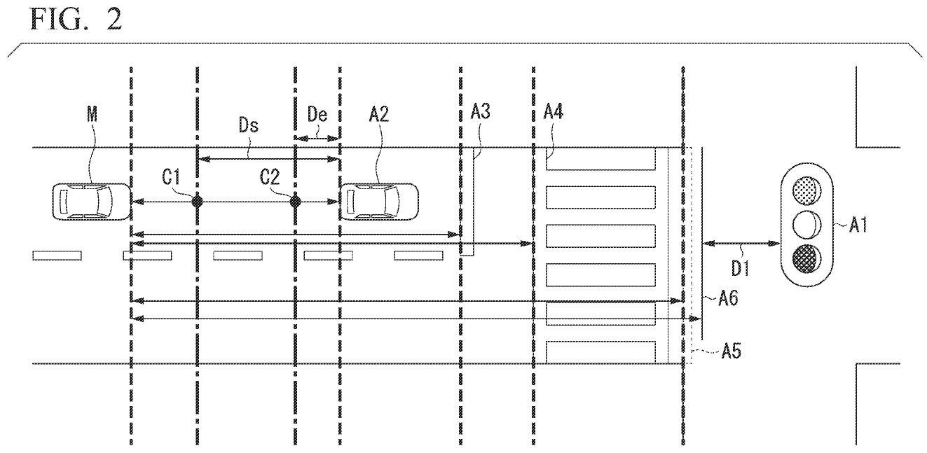

FIGS. 2, 3 and 4 are diagrams showing reference objects recognized by the driving assistance device 100. Reference objects recognized by the recognizer 120 of the driving assistance device 100 on the basis of an image of the front in the own vehicle M may include a traffic signal A1, another vehicle A2, a temporary stop line A3, a pedestrian crossing A4, and an intersection end A5. The other vehicle A2 is another vehicle present in front of the own vehicle M in a lane in which the own vehicle M is traveling. The recognizer 120 uses, as a calculation reference, an object closest to the own vehicle M among the other vehicle A2, the temporary stop line A3, the pedestrian crossing A4, the intersection end A5, and a location A6 that is close to the own vehicle M by a distance D1 from the traffic signal A1. The distance D1 is, for example, about 2 m. When a vehicle enters the intersection, the vehicle passes through the temporary stop line A3, the pedestrian crossing A4, the intersection end A5, and the location A6 in this order. Therefore, in a case where the recognizer 120 recognizes two or more of the temporary stop line A3, the pedestrian crossing A4, and the intersection end A5 as reference objects, the reference determiner 142 selects, as a reference candidate, a reference object close to the own vehicle M on the basis of information regarding the types of the reference objects. As described above, it is possible to select a reference object that is close to the own vehicle M depending on the type of the reference object without actually measuring a distance. If none of the temporary stop line A3, the pedestrian crossing A4, and the intersection end A5 is recognized, the reference determiner 142 uses the location A6 as a reference candidate. The recognizer 120 may calculate a distance between the own vehicle M and the temporary stop line A3, a distance between the own vehicle M and the pedestrian crossing A4, a distance between the own vehicle M and the intersection end A5, and a distance between the own vehicle M and the location A6 and may select a reference object with the shortest distance as a reference candidate.

In a case where the other vehicle A2 is not recognized, the reference determiner 142 uses a rear end of the reference candidate as a calculation reference. On the other hand, in a case where the other vehicle A2 is recognized, the reference determiner 142 compares a distance between the own vehicle M and the other vehicle A2 with a distance between the own vehicle M and the reference candidate. As shown in FIG. 2, in a case where the distance between the own vehicle M and the other vehicle A2 is shorter, the reference determiner 142 determines a rear end of the other vehicle A2 as a calculation reference. The reference determiner 142 uses a location C1 that is separated by the distance Ds from the rear end of the other vehicle A2 in the direction of the own vehicle M as a notification start reference. The reference determiner 142 uses a location C2 that is separated by the distance De from the rear end of the other vehicle A2 in the direction of the own vehicle M as a notification end reference.

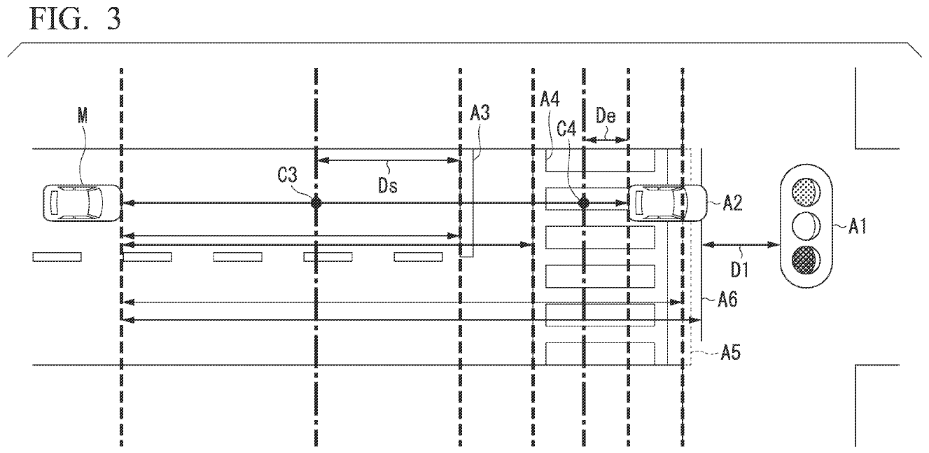

On the other hand, as shown in FIG. 3, in a case where the distance between the own vehicle M and the reference candidate is shorter, the reference determiner 142 determines the rear end of the reference candidate as a calculation reference. In FIG. 3, the reference determiner 142 determines the rear end of the temporary stop line A3 as a calculation reference. The reference determiner 142 uses a location C3 that is separated by the distance Ds from the rear end of the temporary stop line A3 in the direction of the own vehicle M, as a notification start reference. The reference determiner 142 uses a location C4 that is separated by the distance De from the rear end of the other vehicle A2 in the direction of the own vehicle M, as a notification end reference.

When it is determined that the own vehicle M has passed the notification start reference, the notification controller 140 provides a notification based on an advancing feasibility indication by the traffic signal A1 recognized by the recognizer 120. For example, in a case where a lighting color of the traffic signal A1 is yellow or red and a speed of the own vehicle M is equal to or higher than a predetermined speed at a timing when the own vehicle M passes the notification start reference, the notification controller 140 notifies an occupant of advancing prohibition.

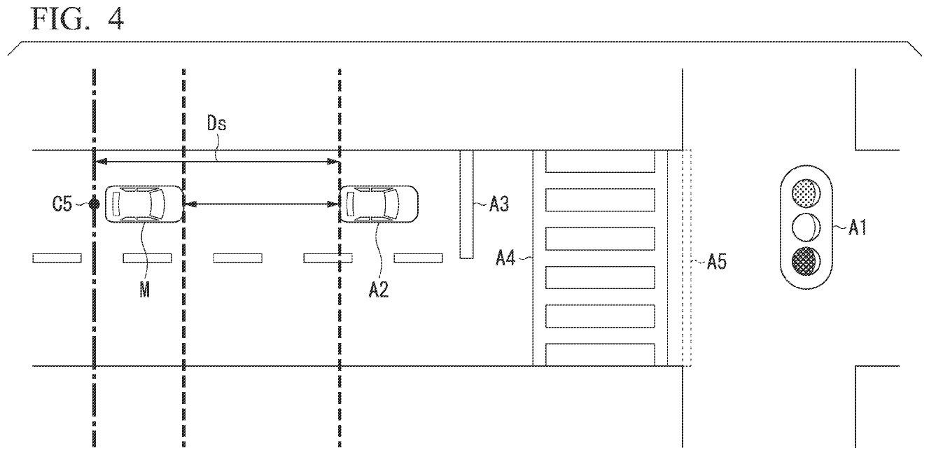

In FIG. 4, the reference determiner 142 uses a location C5 that is separated by the distance De from the rear end of the other vehicle A2 in the direction of the own vehicle M, as a notification start reference. At a timing at which the recognizer 120 recognizes an advancing prohibition indication by the traffic signal A1, the own vehicle M has already passed the notification start reference. In this case, the notification controller 140 immediately notifies the occupant of the advancing prohibition.

The reference determiner 142 may use a line segment that passes through the locations C1, C3, or C5 and is perpendicular to the advancing direction of the own vehicle M as a notification start reference or may use a circumference of a circle of which the radius centered on the rear end of the calculation reference is the distance Ds as a notification start reference. Similarly, the reference determiner 142 may use a line segment that passes through the location C2 or the location C4 and is perpendicular to the advancing direction of the own vehicle M as a notification end reference or may use a circumference of a circle of which the radius centered on the rear end of the other vehicle A2 is the distance De as a notification end reference.

The reference determiner 142 determines a new notification start reference and a new notification end reference each time the recognizer 120 performs recognition on the basis of a new image. The notification controller 140 provides a notification on the basis of the determined new notification start reference and new notification end reference.

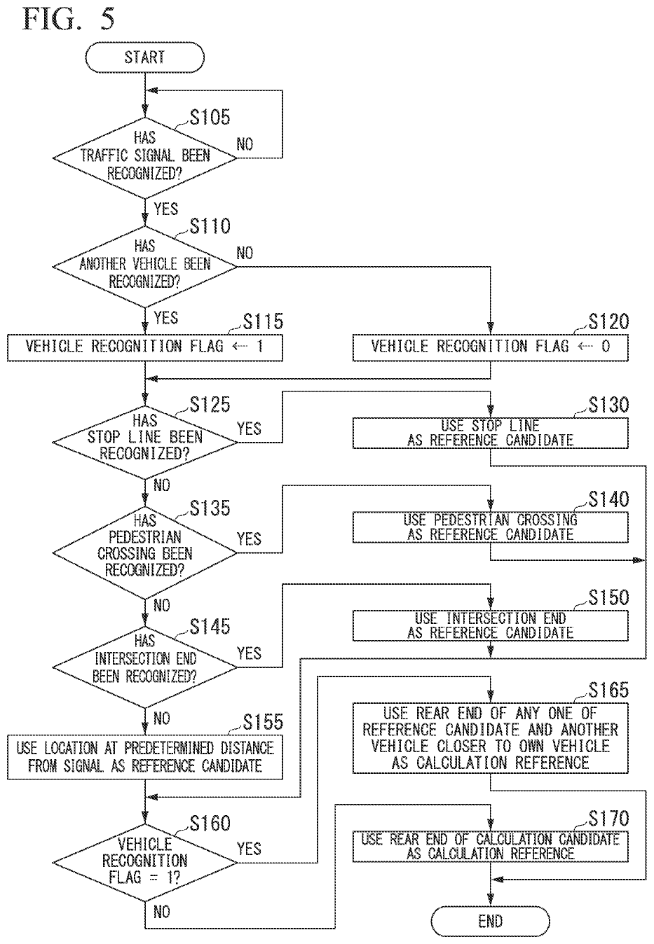

FIG. 5 is a flowchart showing a calculation reference determination process executed by the driving assistance device 100. The driving assistance device 100 repeatedly performs the calculation reference determination process shown in FIG. 5.

The reference determiner 142 determines whether or not the recognizer 120 has recognized a traffic signal on the basis of an image of the front in the own vehicle M (step S105). In a case where it is determined that the recognizer 120 has not recognized the traffic signal, the reference determiner 142 repeatedly performs the process in step S105. In a case where it is determined that the recognizer 120 has recognized the traffic signal, the reference determiner 142 determines whether or not another vehicle in front of the own vehicle M in a travel lane has been recognized (step S110). The reference determiner 142 sets 1 in a vehicle recognition flag in a case where it is determined that another vehicle has been recognized in step S110 (step S115) and sets the vehicle recognition flag to 0 in a case where it is determined that another vehicle has not been recognized in step S110 (step S120).

The reference determiner 142 determines whether or not the recognizer 120 has recognized a temporary stop line in front of the own vehicle M (step S125). In a case where it is determined that the recognizer 120 has recognized a temporary stop line, the reference determiner 142 uses the temporary stop line as a reference candidate (step S130). In a case where it is determined that the recognizer 120 has not recognized a temporary stop line, the reference determiner 142 determines whether or not the recognizer 120 has recognized a pedestrian crossing in front of the own vehicle M (step S135). In a case where it is determined that the recognizer 120 has recognized a pedestrian crossing, the reference determiner 142 uses the pedestrian crossing as a reference candidate (step S140). In a case where it is determined that the recognizer 120 has not recognized a pedestrian crossing, the reference determiner 142 determines whether or not the recognizer 120 has recognized an intersection end in front of the own vehicle M (step S145). In a case where it is determined that the recognizer 120 has recognized an intersection end, the reference determiner 142 uses the intersection end as a reference candidate (step S150). In a case where it is determined that the recognizer 120 has not recognized an intersection end, the reference determiner 142 uses a location close to the own vehicle M by a predetermined distance from the traffic signal recognized by the recognizer 120 in step S105 as a reference candidate (step S155).

The reference determiner 142 determines whether or not the vehicle recognition flag is 1 after the process in step S130, step S140, step S150, or step S155 (step S160). In a case where it is determined that the vehicle recognition flag is 1, the reference determiner 142 acquires a position of the rear end of the reference candidate and a position of the rear end of the other vehicle recognized by the recognizer 120. The reference determiner 142 calculates a distance between the own vehicle M and the rear end of the reference candidate and a distance between the own vehicle M and the rear end of the other vehicle on the basis of the acquired position information. The reference determiner 142 determines the rear end of the reference candidate or the rear end of the other vehicle, which is closer to the own vehicle M, as a calculation reference (step S165). On the other hand, in a case where it is determined that the vehicle recognition flag is 1, the reference determiner 142 determines the rear end of the reference candidate as a calculation reference (step S170).

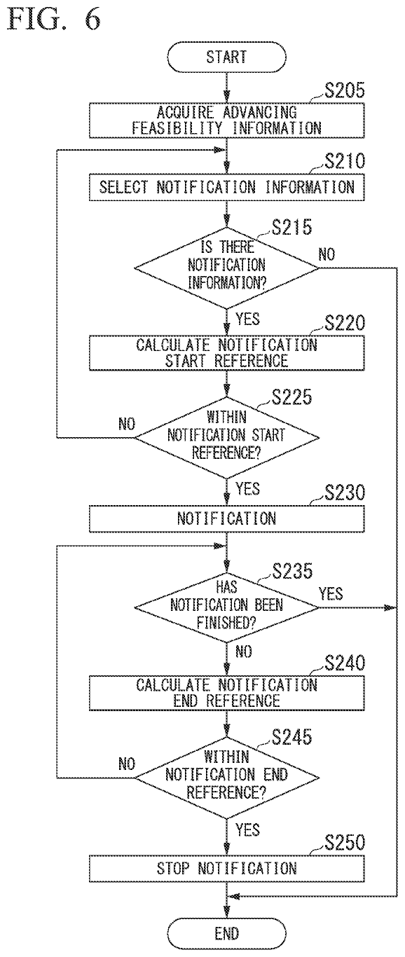

FIG. 6 is a flowchart showing a notification process executed by the driving assistance device 100. The driving assistance device 100 performs the notification process shown in FIG. 6 after the calculation reference determination process in FIG. 5.

The notification controller 140 acquires advancing feasibility information from the recognizer 120 (step S205). For example, the recognizer 120 determines that advancing is permitted in a case where a lighting color of the traffic signal is green and determines that advancing is not permitted in a case where the lighting color of the traffic signal is yellow or red. The recognizer 120 may determine that advancing is not permitted in a case where the traffic signal is an arrow type signal and a direction indicated by a road surface marking and a permitted advancing direction indicated by the traffic signal do not match. The recognizer 120 may determine that advancing is not permitted in a case where a turn signal indication of the own vehicle M and a permitted vehicle advancing direction indicated by the traffic signal do not match.

The notification controller 140 selects notification information according to the advancing feasibility information (step S210). The notification controller 140 may select the notification information by further using other information such as a speed of the own vehicle M in addition to the advancing feasibility information. In a case where a notification is not required, notification information is not selected. The notification controller 140 determines whether or not the notification information has been acquired in step S210 (step S215). In a case where it is determined that notification information has not been acquired, the notification controller 140 finishes the process in FIG. 6.

In a case where it is determined that the notification information has been acquired, the notification controller 140 calculates a notification start reference by using the calculation reference determined by the reference determiner 142 (step S220). The reference determiner 142 uses a location separated from the calculation reference by the distance Ds in the direction of the own vehicle M as a notification start reference. The distance Ds is, for example, a predetermined distance or a distance corresponding to a speed of the own vehicle M. The notification controller 140 determines whether or not the own vehicle M is closer to the calculation reference than the notification start reference (step S225). In a case where it is determined that the own vehicle M is farther from the calculation reference than the notification start reference, the notification controller 140 repeatedly performs the process from step S210. In a case where it is determined that the own vehicle M is farther from the calculation reference than the notification start reference, the notification controller 140 may repeatedly perform the process from step S225 or finish the process in FIG. 6. In a case where it is determined that the own vehicle M is closer to the calculation reference than the notification start reference, the notification controller 140 causes the HMI 30 to output the notification information (step S230). The notification information includes screen data, voice data, and the like to be output from the HMI 30.

The notification controller 140 determines whether or not the notification has been finished (step S235). In a case where it is determined that the notification has been finished, the notification controller 140 finishes the process in FIG. 6. In a case where it is determined that the notification has not been finished, the notification controller 140 calculates a location separated from the other vehicle in front of the own vehicle M in the travel lane in the direction of the own vehicle M by the distance De as a notification end reference (step S240). The distance De is, for example, a predetermined distance or a distance corresponding to a speed of the own vehicle M. The notification controller 140 determines whether or not the own vehicle M is closer to the other vehicle than the notification end reference (step S245). In a case where it is determined that the own vehicle M is farther from the other vehicle than the notification end reference, or in a case where the other vehicle is not recognized, the notification controller 140 repeatedly performs the process from step S235. In a case where it is determined that the own vehicle M is closer to the other vehicle than the notification end reference, the notification controller 140 stops the notification (step S250). This is because the own vehicle M is approaching the other vehicle traveling in front, and a probability that the own vehicle M may enter a collision mitigation brake region increases. By stopping the notification, it becomes easier for the occupant to pay attention to the other vehicle that is approaching. In a case where it is determined that the own vehicle M has entered the collision mitigation brake region, the travel controller 160 controls the brake device 210.

The driving assistance device 100 may perform the notification process shown in FIG. 6 in a case where the recognizer 120 detects the traffic signal and may perform the processes in and after step S110 shown in FIG. 5 before the process in step S220.

According to the embodiment described above, the driving assistance device determines a reference point for calculating a timing of providing a notification based on a detection result of a traffic signal to an occupant of a vehicle according to the type of reference object present between the own vehicle and the traffic signal. Therefore, it is possible to provide a notification at a timing according to a situation of an intersection or a situation of another vehicle or the like traveling in front of the own vehicle

Instead of the vehicle of the above embodiment, another moving object such as a robot may be used.

The embodiment described above may be expressed as follows.

A driving assistance device including:

a storage device that stores a program; and

a hardware processor,

in which the hardware processor executes the program stored in the storage device to be configured to

on the basis of an image of the front in a vehicle, recognize an advancing feasibility indication by a traffic signal and reference objects present between the traffic signal and the vehicle, and

in a case where there is a predetermined type of reference object among the recognized reference objects, use a rear end of the predetermined type of reference object as a reference, and control a notification device such that a notification is provided to an occupant of the vehicle according to a distance from the reference to the vehicle and a recognition result of the advancing feasibility indication.

As mentioned above, the mode for carrying out the present invention has been described by using the embodiment, but the present invention is not limited to the embodiment, and various modifications and replacements may occur within the scope without departing from the scope of the present invention.

What is claimed is:

1. A driving assistance device comprising:
a recognizer that, based on an image of a front in a vehicle, recognizes an advancing feasibility indication by a traffic signal and reference objects present between the traffic signal and the vehicle; and
a notification controller that, in a case where there is a predetermined type of reference object among the reference objects recognized by the recognizer, uses a rear end of the predetermined type of reference object as a reference, and controls a notification device such that a notification is provided to an occupant of the vehicle according to a distance from the reference to the vehicle and a recognition result of the advancing feasibility indication.

2. The driving assistance device according to claim 1,
wherein the predetermined type of reference object includes a stop line and another vehicle present in front of the vehicle in a lane in which the vehicle is traveling, and
wherein, in a case where the recognized reference objects include the stop line and the other vehicle, the notification controller uses a rear end of a reference object, which is any one of the stop line and the other vehicle and which is closer to the vehicle, as the reference.

3. The driving assistance device according to claim 2,
wherein the predetermined type of reference object further includes a pedestrian crossing, and
wherein, in a case where the recognized reference objects do not include the stop line and include the pedestrian crossing and the other vehicle, the notification controller uses a rear end of a reference object, which is any one of the pedestrian crossing and the other vehicle and which is closer to the vehicle, as the reference.

4. The driving assistance device according to claim 3,
wherein the predetermined type of reference object further includes an intersection end, and
wherein, in a case where the recognized reference objects do not include the stop line and the pedestrian crossing, and include the intersection end and the other vehicle, the notification controller uses a rear end of a reference object, which is any one of the intersection end and the other vehicle and which is closer to the vehicle, as the reference.

5. The driving assistance device according to claim 4,
wherein, in a case where the recognized reference objects do not include any of the stop line, the pedestrian crossing, and the intersection end, the notification controller uses a position, which is any one of a position at a predetermined distance from the traffic signal in a direction of the vehicle and a position of the rear end of the other vehicle and which is closer to the vehicle, as the reference.

6. The driving assistance device according to claim 2,
wherein the notification controller controls the notification device such that the notification is stopped in a case where a distance between the vehicle and the other vehicle is equal to or shorter than a predetermined distance.

7. The driving assistance device according to claim 1,
wherein the notification controller controls the notification device such that the notification is provided according to the recognition result of the advancing possibility indication and a speed of the vehicle.

8. The driving assistance device according to claim 1,
wherein the notification controller controls the notification device such that the notification is provided in a case where a distance between the reference and the vehicle is within a distance corresponding to a speed of the vehicle.

9. The driving assistance device according to claim 1,
wherein the vehicle includes an image acquirer that acquires the image of the front in the vehicle.

10. A driving assistance method by way of a computer, comprising:
based on an image of a front in a vehicle, recognizing an advancing feasibility indication by a traffic signal and reference objects present between the traffic signal and the vehicle; and
in a case where there is a predetermined type of reference object among the recognized reference objects, using a rear end of the predetermined type of reference object as a reference, and controlling a notification device such that a notification is provided to an occupant of the vehicle according to a distance from the reference to the vehicle and a recognition result of the advancing feasibility indication.

11. A non-transitory computer readable recording medium including a program causing a computer to:
based on an image of a front in a vehicle, recognize an advancing feasibility indication by a traffic signal and reference objects present between the traffic signal and the vehicle; and
in a case where there is a predetermined type of reference object among the recognized reference objects, use a rear end of the predetermined type of reference object as a reference, and control a notification device such that a notification is provided to an occupant of the vehicle according to a distance from the reference to the vehicle and a recognition result of the advancing feasibility indication.
